(19) United States
(12) Patent Application Publication
(10) Pub. No.: US 2015/0084889 A1
(43) Pub. Date: Mar. 26, 2015

(54) STROKE PROCESSING DEVICE, STROKE PROCESSING METHOD, AND COMPUTER PROGRAM PRODUCT

(71) Applicant: Kabushiki Kaisha Toshiba, Tokyo (JP)

(72) Inventor: Yojiro TONOUCHI, Tokyo (JP)

(21) Appl. No.: 14/481,155

(22) Filed: Sep. 9, 2014

(30) Foreign Application Priority Data
Sep. 24, 2013 (JP) 2013-197137

(51) Int. Cl. G06F 3/0488; G06F 3/041; G06F 3/0354

(52) U.S. Cl. CPC G06F 3/04883; G06F 3/03545; G06F 3/041
USPC 345/173

(57) ABSTRACT

According to an embodiment, a device includes a first updating controller, a converter, a second updating controller, and a display controller. The first updating controller is configured to, when a graphic pattern similar to a partial stroke made of pairs of first coordinates is not present, update values of pairs of second coordinates with values of the corresponding pairs of first coordinates. The converter is configured to, when the graphic pattern is present, convert the pairs of first coordinates constituting the partial stroke into pairs of converted coordinates constituting the graphic pattern. The second updating controller is configured to, when the graphic pattern is present, update values of the pairs of second coordinates corresponding to the partial stroke to values of the pairs of converted coordinates of the pairs of first coordinates. The display controller is configured to display the display stroke based on the pairs of second coordinates.

### CROSS-REFERENCE TO RELATED APPLICATION

This application is based upon and claims the benefit of priority from Japanese Patent Application No. 2013-197137, filed on Sep. 24, 2013; the entire contents of which are incorporated herein by reference.

### FIELD

Embodiments described herein relate generally to a stroke processing device, a stroke processing method, and a computer program product.

### BACKGROUND

A technology is known in which an input stroke that has been input by a user by hand is converted into a display stroke used for the display purpose.

However, in the conventional technology described above, conversion of an input stroke into a display stroke is performed after the input stroke has been completely input. For that reason, while the user is inputting an input stroke, he or she cannot understand whether or not the input stroke would be converted into the intended stroke.

In that regard, it is an object of the invention to provide a stroke display device, a stroke display method, and a computer program product that, while a user is inputting an input stroke, enables the user to understand whether or not the input stroke would be converted into the intended stroke.

### BRIEF DESCRIPTION OF THE DRAWINGS

FIG. 1 is a configuration diagram illustrating an example of a stroke processing device according to an embodiment;

FIG. 2 is a diagram illustrating an example of the information stored in a storage according to the embodiment;

FIG. 3 is an explanatory diagram of an example of a conversion method for obtaining a pair of converted coordinates according to the embodiment;

FIGS. 4 to 7 are diagrams illustrating a display example of a display stroke according to the embodiment;

FIG. 8 is a flowchart for explaining an exemplary sequence of operations according to the embodiment;

FIG. 9 is a flowchart for explaining another example of the sequence of operations according to the embodiment; and

FIG. 10 is a block diagram illustrating an exemplary hardware configuration of the stroke processing device according to the embodiment.

### DETAILED DESCRIPTION

According to an embodiment, a stroke processing device includes an procurement controller, storage, a controller, a first updating controller, a converter, a second updating controller, and a display controller. The procurement controller is configured to obtain a pair of first coordinates of an input stroke. The storage is configured to store the pair of first coordinates and a pair of second coordinates of a display stroke used for displaying in association with the pair of first coordinates every time the procurement controller obtains the pair of first coordinates. The controller is configured to obtain a first number of pairs of first coordinates previously stored in reverse chronological order from the storage every time the procurement controller obtains the pair of first coordinates, and determine whether or not there exists a graphic pattern similar to a partial stroke made of two or more pairs of first coordinates including the pair of first coordinates obtained by the procurement controller and at least one pair of first coordinates from among the first number of pairs of first coordinates. The first updating controller is configured to, when the graphic pattern is not present, update values of second pairs of second coordinates associated with the first number of pairs of first coordinates with values of first pairs of first coordinates associated with the second pairs of second coordinates, and store, in the storage, the pair of first coordinates obtained by the procurement controller and the pair of second coordinates having a value of the pair of first coordinates. The converter is configured to, when the graphic pattern is present, convert the two or more pairs of first coordinates constituting the partial stroke into two or more pairs of converted coordinates constituting the graphic pattern. The second updating controller is configured to, when the graphic pattern is present, update values of the second pairs of second coordinates associated with the first pairs of first coordinates, from among the first number of pairs of first coordinates, constituting the partial stroke to values of third pairs of converted coordinates of the first pairs of first coordinates associated with the second pairs of second coordinates, and store, in the storage, the pair of first coordinates obtained by the procurement controller and the pair of second coordinates having a value of the pair of converted coordinates. The display controller is configured to display, on a display, the display stroke based on the second pairs of second coordinates stored in the storage.

An exemplary embodiment of the invention is described below in detail with reference to the accompanying drawings.

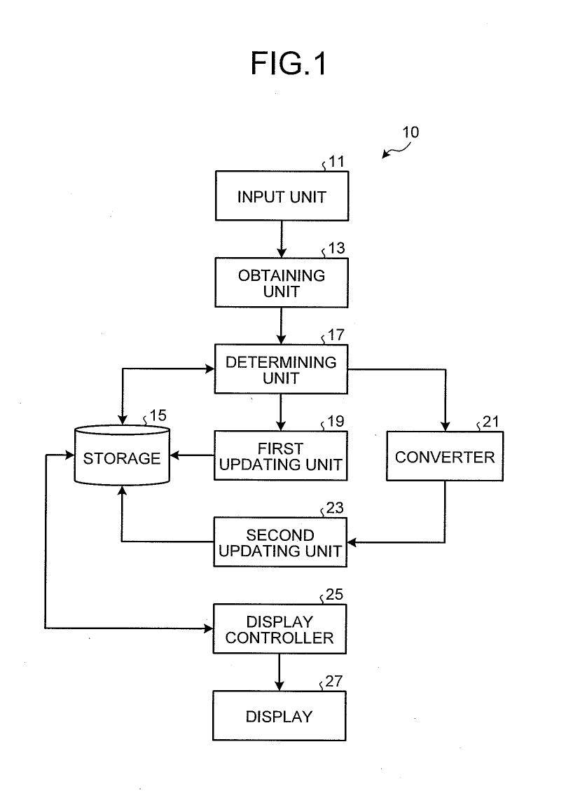

FIG. 1 is a configuration diagram illustrating an example of a stroke processing device 10 according to the embodiment. As illustrated in FIG. 1, the stroke processing device 10 includes an input unit 11, an obtaining unit 13, a storage 15, a determining unit 17, a first updating unit 19, a converter 21, a second updating unit 23, a display controller 25, and a display 27.

The input unit 11 can be implemented using an input device such as a touch-sensitive panel, a touch-pad, a mouse, or an electronic pen that enables handwritten input. The obtaining unit 13, the determining unit 17, the first updating unit 19, the converter 21, the second updating unit 23, and the display controller 25 can be implemented by executing computer programs in a processing device such as a central processing unit (CPU), that is, can be implemented using software; or can be implemented using hardware such as an integrated circuit (IC); or can be implemented using a combination of software and hardware. The storage 15 can be implemented using a storage device such as a hard disk drive (HDD), a solid state drive (SSD), a memory card, an optical disk, a read only memory (ROM), or a random access memory (RAM) in which information can be stored in a magnetic, optical, or electrical manner. The display 27 can be implemented using a display device such as a touch-sensitive panel display or a liquid crystal display.

The input unit 11 is used by a user to input handwritten input strokes (i.e., input handwriting) to the stroke processing device 10. An input stroke points to a stroke of the handwriting of the user, and represents data of the locus from the time when a stylus pen or a finger makes contact with the input screen of the touch-sensitive panel until it is lifted from the input screen (i.e., the locus from a pen-down action to a pen-up action).

For example, an input stroke is expressed as vector data containing two-dimensional time-series coordinates values, such as {(x(1), y(1)), (x(2), y(2)), . . . }, of the points of contact of the stylus pen or a finger with the input screen. For example, the input stroke at a timing i (where i is a natural number) has the coordinates (x(i), y(i)).

The obtaining unit 13 obtains, in a sequential manner, pairs of first coordinates that represent the coordinates constituting an input stroke which is input from the input unit 11. For example, at a timing 1, the obtaining unit 13 obtains a pair of first coordinates (x(1), y(1)) of the input stroke. Then, at a timing 2, the obtaining unit 13 obtains a pair of first coordinates (x(2), y(2)) of the input stroke. Thus, at a timing i, the obtaining unit 13 obtains a pair of first coordinates (x(i), y(i)) of the input stroke.

The storage 15 stores therein pairs of second coordinates each representing a pair of coordinates of a display stroke used for displaying the input stroke in association with the pairs of first coordinates, respectively. More specifically, the storage 15 stores therein pieces of attribute information each indicating whether the pair of second coordinates is a pair of first coordinates or a pair of converted coordinates obtained by converting the pair of first coordinates by the converter 21 (described later), in association with the pairs of first coordinates, respectively.

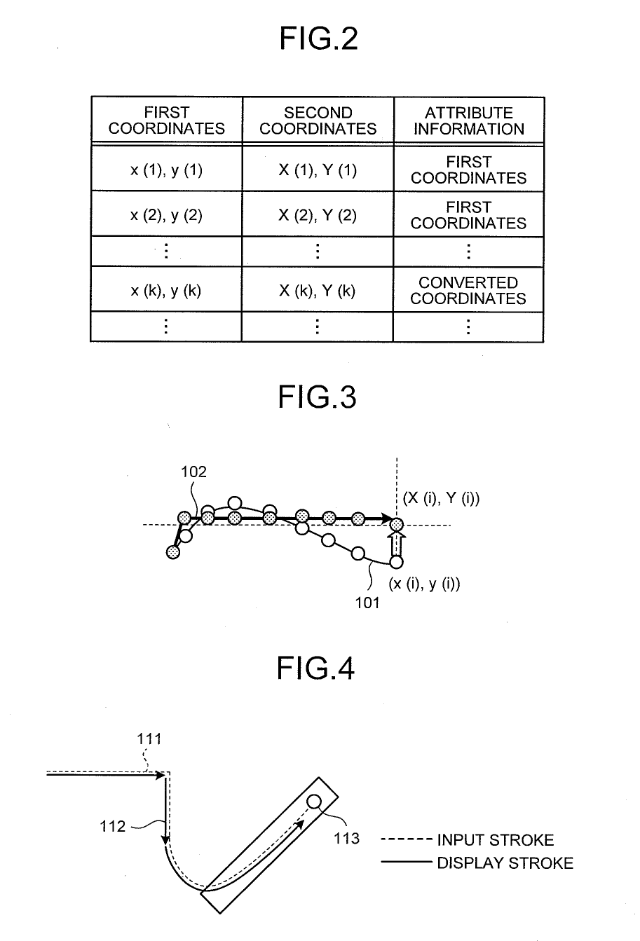

FIG. 2 is a diagram illustrating an example of the information stored in the storage 15 according to the embodiment. In the example illustrated in FIG. 2, the storage 15 stores, in a chronological order, sets (records) each of which contains a pair of first coordinates, a pair of second coordinates, and a piece of attribute information in association with each other. Herein, the writing and updating of first coordinates, second coordinates, and attribute information in the storage 15 is performed by the first updating unit 19 (described later) and the second updating unit 23 (described later).

Every time the obtaining unit 13 obtains a pair of first coordinates, the determining unit 17 obtains a predetermined number of pairs of first coordinates in reverse chronological order from the storage 15, and determines whether or not there exists a graphic pattern similar to a partial stroke made of two or more pairs of first coordinates including a pair of first coordinates obtained by the obtaining unit 13 and at least one pair of first coordinates from among the predetermined number of pairs of first coordinates. More specifically, the determining unit 17 determines whether or not there exists a graphic pattern for which the difference with the partial stroke is equal to or smaller than a threshold value. Meanwhile, if a plurality of partial strokes is similar to a graphic pattern, then the determining unit 17 determines that the partial stroke having the largest number of constituent pairs of first coordinates is similar to the graphic pattern.

More particularly, the determining unit 17 also obtains the attribute information corresponding to the newest pair of first coordinates in chronological order from the storage 15. If that attribute information indicates a pair of first coordinates, then the determining unit 17 determines whether or not there exists a graphic pattern similar to the partial stroke. On the other hand, if the attribute information indicates a pair of converted coordinates, then the determining unit 17 determines whether or not the partial stroke is similar to the previous graphic pattern that was determined to be similar in the previous determination.

For example, when a pair of first coordinates (x(i), y(i)) is obtained from the obtaining unit 13, the determining unit 17 obtains a predetermined number of pairs of first coordinates {(x(k), y(k)), (x(k+1), y(k+1)), . . . , (x(i−1), y(i−1))} in reverse chronological order. These predetermined number of pairs of first coordinates are continuous in chronological order in which (x(i−1), y(i−1)) represents the newest pair of first coordinates and (x(k), y(k)) represents the oldest pair of first coordinate.

Then, the determining unit 17 makes use of {(x(k), y(k)), (x(k+1), y(k+1)), . . . , (x(i−1), y(i−1))} and (x(i), y(i)); generates chronologically-continuous coordinate arrays including (x(i), y(i)); and determines whether or not there exists a graphic pattern similar to the partial stroke made of each coordinate array.

In this case, the following (i−k) number of coordinate arrays are generated: {(x(i−1), y(i−1)), (x(i), y(i))}; {(x(i−2), y(i−2)), (x(i−1), y(i−1)), (x(i), y(i))}; . . . ; {(x(k+1), y(k+1)), . . . , (x(i−1), y(i−1)), (x(i), y(i))}; and {(x(k), y(k)), (x(k+1), y(k+1)), . . . , (x(i−1), y(i−1)), (x(i), y(i))}.

For example, if the target graphic pattern for determination is a straight line, then the determining unit 17 interpolates each coordinate array with a regression line using the method of least squares; and determines that, from among the (i−k) number of coordinate arrays, the coordinate arrays having the approximation error within a threshold value are similar to the straight line. Moreover, when a plurality of coordinate arrays has the approximation error within a threshold value; the determining unit 17 determines that, for example, the coordinate array having the largest number (i−k+1) of coordinates is similar to the straight line.

When the straight line is written as y=ax+b, then the regression problem related to the coordinate time series from “k” to “i” becomes a problem in which two straight line parameters “a” and “b” are obtained that minimize Equation (1).

s(a,b)=Σ(y(i)−ax(i)−b)̂2 (1)

where, Σ represents the summation of i=1 to N.

Regarding this problem, in Equation (2) and Equation (3), S(k, I; a, b) becomes the smallest.

a_min(k,i)=(Σ(x(j)*y(j))−(Σx(j)*Σy(j))/N)/(Σ(x(j)̂2)−(Σx(j)*Σx(j))/N) (2)

b_min(k,i)=(Σy(j)−a_min*Σx(j))/N (3)

Herein, when an approximation error S(k, I; a_min(k, I), b_min(k, I)) falls below a threshold value set in advance, then the corresponding coordinate array is determined to be similar to the straight line. More specifically, for the straight line of each of k= . . . , i−3, i−2, i−1, the approximation error is calculated as . . . , S(i−3, I; a, b), S(i−2, I; a, b), and S(i−1, I; a, b). Then, such “k” is selected for which the approximation error falls below a threshold value. However, when the number (i−k+1) of coordinates is small, sometimes values are present for which the approximation error is small by change. Hence, it is also possible to impose a restriction that (i−k+1) is equal to or greater than a certain value. If it is determined that there exists a plurality of “k” for which the straight line is similar, such “k” corresponding to the largest number (i−k+1) of coordinates can be selected.

Meanwhile, consider the case in which, instead of determining whether or not there exists a graphic pattern similar to the partial stroke, it is determined whether or not the partial stroke is similar to the previous graphic pattern that was determined to be similar in the previous determination. In that case, instead of newly calculating the straight line parameters that minimize the approximation error S(k, I; a, b) at the timing i; it is possible to use straight line parameters (a_min(k, i−1), b_min(k, i−1)), which are approximated during the addition of (x(i−1), y(i−1)) at the timing i−1, without modification.

Herein, if it is determined that approximation cannot be done using the approximated straight line parameters (a_min(k, i−1), b_min(k, i−1)) at the timing i−1; then straight line parameters (a_min(k′, i−1), b_min(k′, i−1)) at the timing i can be newly calculated and a new approximated graphic can be calculated.

When a straight line is written as y=ax+b, if the tilt of the straight line is so large that the straight line approaches being vertical, then the error tends to be large. In order to prevent that from occurring, rotation processing can be performed with respect to each coordinate point so that the direction of the straight line is in the horizontal direction.

If the determining unit 17 determines that there is no graphic pattern similar to the partial stroke or if the determining unit 17 determines that the partial stroke is not similar to the previous graphic pattern, then the first updating unit 19 updates the value of the pair of second coordinates associated with each pair of first coordinates, of a predetermined number of pairs of first coordinates, with the value of that pair of first coordinates; performs an update such that the pieces of attribute information associated with a predetermined number of pairs of first coordinates indicates the pairs of first coordinates; and stores, in the storage 15, the pair of first coordinates obtained by the obtaining unit 13, the pair of second coordinates having the value of that pair of first coordinates, and the piece of attribute information indicating the pair of first coordinates, in association with each other.

For example, when the determining unit 17 determines that there is no graphic pattern similar to the partial stroke, the first updating unit 19 updates each of (X(k), Y(k)), (X(k+1), Y(k+1)), . . . , and (X(i−1), Y(i−1)) with (x(k), y(k)), (x(k+1), y(k+1)), . . . , and (x(i−1), y(i−1)), respectively; and performs an update such that the respective sets of attribute information indicate a pair of first coordinates. Besides, the first updating unit 19 stores, in the storage 15, the pairs of first coordinates (x(i), y(i)), the pairs of second coordinates (x(i), y(i)), and the pieces of attribute information (the pairs of first coordinates), in association with each other.

When the determining unit 17 determines that there exists a graphic pattern similar to the partial stroke, the converter 21 converts each of the two or more pairs of first coordinates constituting the partial stroke into a pair of converted coordinates constituting the graphic pattern. However, when the determining unit 17 determines that the partial stroke is similar to the previous graphic pattern; the converter 21 converts each of the two or more pairs of first coordinates constituting the partial stroke into a pair of converted coordinates constituting the previous graphic pattern.

For example, as illustrated in FIG. 3, the converter 21 converts two or more pairs of first coordinates {(x(k), y(k)), (x(k+1), y(k+1)), . . . , (x(i−1), y(i−1)), (x(i), y(i))} that constitute a partial stroke 101 into two or more pairs of converted coordinates {(X(k), Y(k)), (X(k+1), Y(k+1)), . . . , (X(i−1), Y(i−1)), (X(i), Y(i))} that constitute a graphic pattern (in the example illustrated in FIG. 3, constitute a straight line 102). In this case, a pair of converted coordinates (for example, (X(i), Y(i))) represents the intersection point obtained when a perpendicular line is drawn from a pair of first coordinates (for example, (x(i), y(i)) to the straight line 102.

When the determining unit 17 determines that there exists a graphic pattern similar to the partial stroke or when the determining unit 17 determines that the partial stroke is similar to the previous graphic pattern, the second updating unit 23 updates the values of the pairs of second coordinates associated with the respective pairs of first coordinates that, from among a predetermined number of pairs of first coordinates, constitutes the partial stroke to the values of the pairs of converted coordinates of the pairs of first coordinates associated with the concerned pairs of second coordinates; performs an update such that each piece of attribute information associated with each pair of first coordinates that, from among a predetermined number of pairs of first coordinates, constitutes the partial stroke indicates a pair of converted coordinates; and stores, in the storage 15, the pair of first coordinates obtained by the obtaining unit 13, the pair of second coordinates having the value of the pair of converted coordinates of the pair of first coordinates, and the piece of attribute information each indicating a pair of converted coordinates, in association with each other.

For example, when the determining unit 17 determines that there is no graphic pattern similar to the partial stroke, the first updating unit 19 updates the pair of second coordinates with (X(k), Y(k)), (X(k+1), Y(k+1)), . . . , and (X(i−1), Y(i−1)) and performs an update such that the respective pieces of attribute information indicate a pair of second coordinates. Besides, the second updating unit 23 stores the pairs of first coordinates (x(i), y(i)), the pairs of second coordinates (x(i), Y(i)), and the pieces of attribute information (the pairs of second coordinates) in association with each other in the storage 15.

The display controller 25 displays, on the display 27, a display stroke using a plurality of pairs of second coordinates stored in the storage 15. For example, the display controller 25 joins a plurality of pairs of second coordinates, which is stored in the storage 15, and displays a display stroke on the display 27. Alternatively, the display controller 25 can perform spline interpolation and display a display stroke on the display 27. Meanwhile, along with displaying a display stroke, the display controller 25 can also display the corresponding input stroke on the display 27. In that case, it is desirable that the display controller 25 display the input stroke with a different color or a different line type than the display stroke.

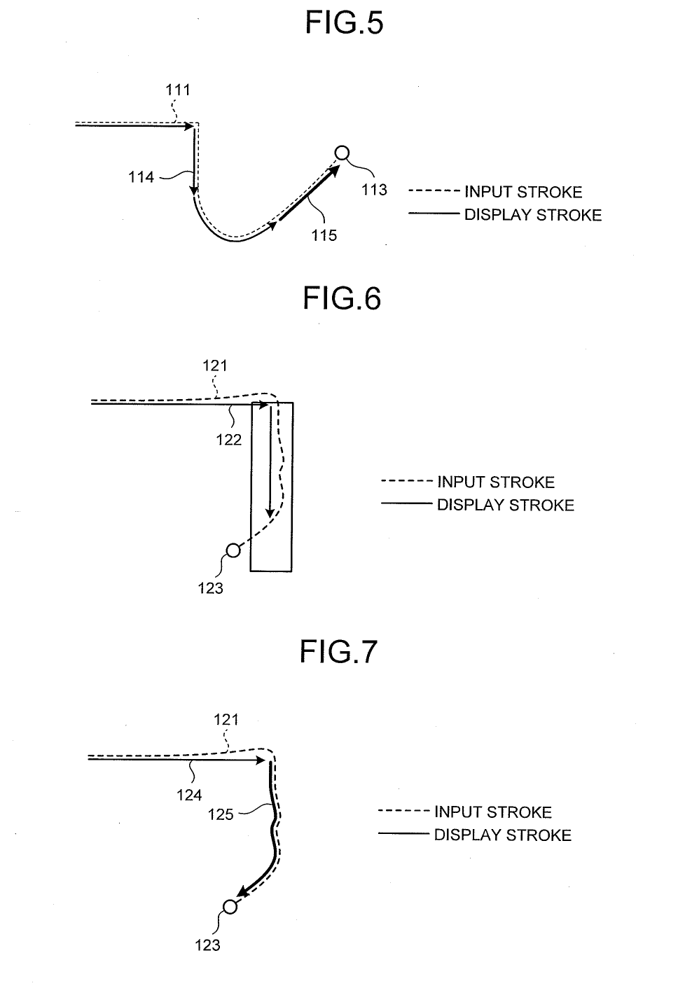

According to the embodiment, as illustrated in FIG. 4, prior to the addition of a pair of coordinates 113 to an input stroke 111, the leading end portion of a display stroke 112 is unchanged from the stroke that is drawn freehand. In contrast, as illustrated in FIG. 5, after the addition of the pair of coordinates 113 to the input stroke 111, a straight line is substituted as a leading end portion 115 of a display stroke 114.

Moreover, as illustrated in FIG. 6, prior to the addition of a pair of coordinates 123 to an input stroke 121, a straight line is substituted as the leading end portion of a display stroke 122. In contrast, as illustrated in FIG. 7, after the addition of the pair of coordinates 123 to the input stroke 121, a stroke drawn freehand is substituted as a leading end portion 125 of a display stroke 124.

In this way, according to the embodiment, while an input stroke is being input by the user, the input stroke is converted into a display stroke that is believed to be the user-intended stroke. Hence, while an input stroke is being input by the user, it becomes possible to make the user understand whether or not the input stroke would be converted into the user-intended stroke.

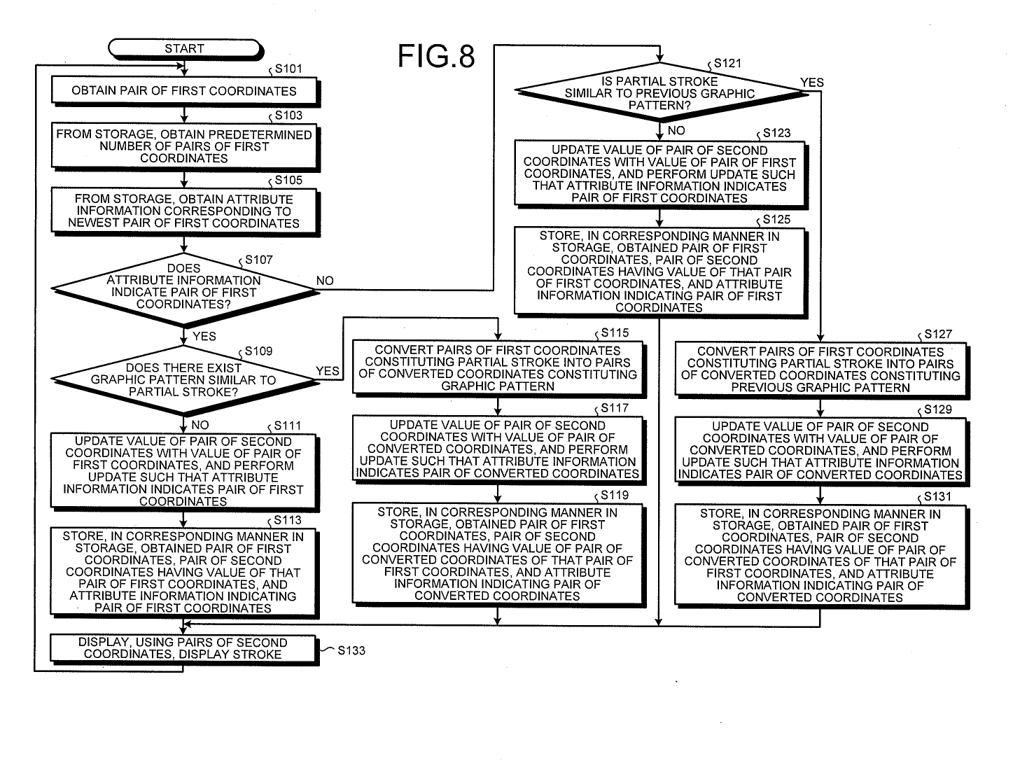

FIG. 8 is a flowchart for explaining an exemplary sequence of operations performed in the stroke processing device 10 according to the embodiment.

Firstly, the obtaining unit 13 obtains the pairs of first coordinates that represent the coordinates constituting an input stroke which is input from the input unit 11 (Step S101).

Once the obtaining unit 13 obtains the first coordinates, the determining unit 17 obtains, from the storage 15, a predetermined number of pairs of first coordinates in reverse chronological order (Step S103); as well as obtains, from the storage 15, the piece of attribute information associated with the newest pair of first coordinates in chronological order (Step S105).

If the piece of attribute information indicates a pair of first coordinates (Yes at Step S107), then the determining unit 17 determines whether or not there exists a graphic pattern similar to a partial stroke (Step S109).

If there is no similar graphic pattern (No at Step S109), then the first updating unit 19 updates the values of the pairs of second coordinates associated with a predetermined number of pairs of first coordinates, with the values of the pairs of first coordinates, and performs an update such that the pieces of attribute information associated with the predetermined number of pairs of first coordinates indicate a pair of first coordinates (Step S111).

Subsequently, the first updating unit 19 stores, in the storage 15, the pair of first coordinates obtained by the obtaining unit 13, the pair of second coordinates having the value of a pair of first coordinates, and the piece of attribute information which indicates a pair of first coordinates, in association with each other (Step S113).

Then, the display controller 25 displays, on the display 27, a display stroke using a plurality of pairs of second coordinates stored in the storage 15 (Step S133). After that, the system control returns to Step S101.

Meanwhile, if a similar graphic pattern is present (Yes at Step S109), then the converter converts the two or more pairs of first coordinates constituting the partial stroke into two or more pairs of converted coordinates constituting the graphic pattern (Step S115).

Then, the second updating unit 23 updates the values of the pairs of second coordinates associated with the pairs of first coordinates that, from among a predetermined number of pairs of first coordinates, constitutes the partial stroke to the values of the pairs of converted coordinates of the pairs of first coordinates associated with the concerned pairs of second coordinates; and performs an update such that the pieces of attribute information associated with the pairs of first coordinates that, from among a predetermined number of pairs of first coordinates, constitute the partial stroke indicate a pair of converted coordinates (Step S117).

Subsequently, the second updating unit 23 stores, in the storage 15, the pairs of first coordinates obtained by the obtaining unit 13, the pairs of second coordinates each having the value of the pair of converted coordinates of a pair of first coordinates, and the pieces of attribute information each indicating a pair of converted coordinates, in association with each other (Step S119).

Then, the display controller 25 displays, on the display 27, a display stroke using a plurality of pairs of second coordinates stored in the storage 15 (Step S133). After that, the system control returns to Step S101.

Meanwhile, if the piece of attribute information indicates a pair of converted coordinates (No at Step S107), then the determining unit 17 determines whether or not the partial stroke is similar to the previous graphic pattern (Step S121).

If the partial stroke is not similar to the previous graphic pattern (No at Step S121), then the first updating unit 19 updates the values of the pairs of second coordinates associated with the respective pairs of first coordinates, of a predetermined number of pairs of first coordinates, with the values of the pairs of first coordinates, and performs an update such that the pieces of attribute information associated with the predetermined number of pairs of first coordinates indicate a pair of first coordinates (Step S123).

Subsequently, the first updating unit 19 stores, in the storage 15, the pairs of first coordinates obtained by the obtaining unit 13, the pairs of second coordinates each having the value of a pair of first coordinates, and the pieces of attribute information each indicating a pair of first coordinates, in association with each other (Step S125).

Then, the display controller 25 displays, on the display 27, a display stroke using a plurality of pairs of second coordinates stored in the storage 15 (Step S133). After that, the system control returns to Step S101.

Meanwhile, if the partial stroke is similar to the previous graphic pattern (Yes at Step S121), then the converter 21 converts the two or more pairs of first coordinates constituting the partial stroke into two or more pairs of converted coordinates constituting the previous graphic pattern (Step S127).

Then, the second updating unit 23 updates the values of the pairs of second coordinates associated with the respective pairs of first coordinates that, from among a predetermined number of pairs of first coordinates, constitutes the partial stroke to the values of the pairs of converted coordinates of the pairs of first coordinates associated with the concerned pairs of second coordinates; and performs an update such that the pieces of attribute information associated with the pairs of first coordinates that, from among a predetermined number of pairs of first coordinates, constitute the partial stroke indicate a pair of converted coordinates (Step S129).

Subsequently, the second updating unit 23 stores, in the storage 15, the pair of first coordinates obtained by the obtaining unit 13, the pair of second coordinates each having the value of the pair of converted coordinates of a pair of first coordinates, and the piece of attribute information which indicates a pair of converted coordinates, in association with each other (Step S131).

Then, the display controller 25 displays, on the display 27, a display stroke using a plurality of pairs of second coordinates stored in the storage 15 (Step S133). After that, the system control returns to Step S101.

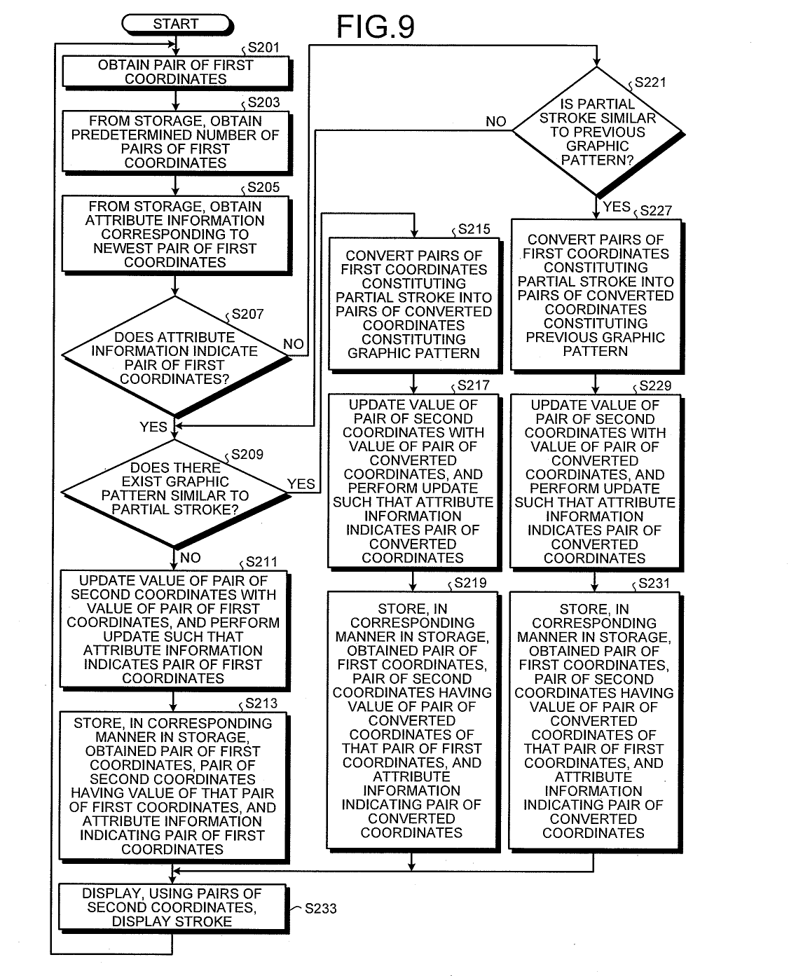

FIG. 9 is a flowchart for explaining another example of the sequence of operations performed in the stroke processing device 10 according to the embodiment.

In the example illustrated in FIG. 9, when the determining unit 17 determines that the partial stroke is not similar to the previous graphic pattern (No at Step S221), the system control proceeds to Step S209. Then, the determining unit 17 determines whether or not there exists a graphic pattern similar to the partial stroke (Step S209).

Herein, the operations performed from Step S201 to Step S219 are identical to the operations performed Step S101 to Step S119 illustrated in the flowchart in FIG. 8, while the operations performed from Step S227 to Step S233 are identical to the operations performed Step S127 to Step S133 illustrated in the flowchart in FIG. 8.

In this way, according to the embodiment, while an input stroke is being input by the user, it is converted into a display stroke that is believed to be the user-intended stroke. Hence, while an input stroke is being input by the user, it becomes possible to make the user understand whether or not the input stroke would be converted into the user-intended stroke.

Particularly, according to the embodiment, while an input stroke is being input, it is determined whether or not there exists a partial line segment or a partial polygonal line. Then, depending on the determination result, the partial line segment or the partial polygonal line is converted into a straight line before being displayed. For that reason, while an input stroke is being input by the user, it becomes possible to make the user understand whether or not a partial line segment or a partial polygonal line would be converted into the user-intended stroke.

Hardware Configuration

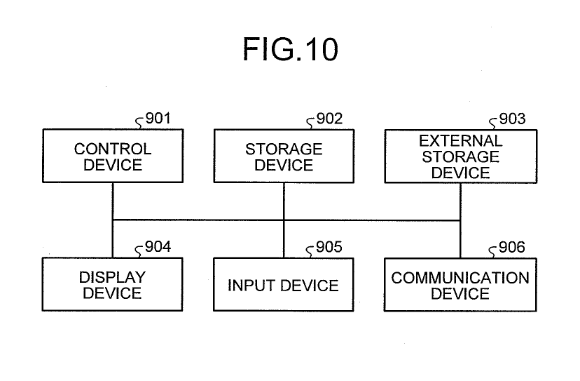

FIG. 10 is a block diagram illustrating an exemplary hardware configuration of the stroke processing device 10 according to the embodiment. As illustrated in FIG. 10, the stroke processing device 10 according to the embodiment can be implemented using the hardware configuration of a commonly-used computer that includes a control device 901 such as a central processing unit (CPU); a storage device 902 such as a read only memory (ROM) or a random access memory (RAM); an external storage device 903 such as a hard disk drive (HDD) or a solid state drive (SSD); a display device 904 such as a display; an input device 905 such as a mouse or a keyboard; and a communication device 906 such as a communication I/F.

Meanwhile, the computer programs executed in the stroke processing device 10 according to the embodiment are stored in advance in a ROM or the like. Alternatively, the computer programs executed in the stroke processing device 10 according to the embodiment can be stored in the form of installable or executable files in a computer-readable storage medium such as a compact disk read only memory (CD-ROM), a compact disk readable (CD-R), a memory card, a digital versatile disk (DVD), or a flexible disk (FD), as a computer program product. Still alternatively, the computer programs executed in the stroke processing device 10 according to the embodiment can be saved as downloadable files on a computer connected to the Internet or can be made available for distribution through a network such as the Internet.

The computer programs executed in the stroke processing device 10 according to the embodiment contain modules for each of the abovementioned constituent elements. In practice, for example, the control device 901 loads the computer programs from the external storage device 903 and runs them so that the computer programs are loaded in the storage device 902. As a result, the module for each constituent element of is generated in the computer.

As described above, according to the embodiment, while an input stroke is being input by the user, it becomes possible to make the user understand whether or not the input stroke would be converted into the user-intended stroke.

For example, unless contrary to the nature thereof, the steps of the flowcharts according to the embodiment described above can have a different execution sequence, can be executed in plurality at the same time, or can be executed in a different sequence every time.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A stroke processing device comprising:
a procurement controller configured to obtain a pair of first coordinates of an input stroke;
storage configured to store the pair of first coordinates and a pair of second coordinates of a display stroke used for displaying in association with the pair of first coordinates every time the procurement controller obtains the pair of first coordinates;
a controller configured to obtain a first number of pairs of first coordinates previously stored in reverse chronological order from the storage every time the procurement controller obtains the pair of first coordinates, and determine whether or not there exists a graphic pattern similar to a partial stroke made of two or more pairs of first coordinates comprising the pair of first coordinates obtained by the procurement controller and at least one pair of first coordinates from among the first number of pairs of first coordinates;
a first updating controller configured to, when the graphic pattern is not present, update values of second pairs of second coordinates associated with the first number of pairs of first coordinates with values of first pairs of first coordinates associated with the second pairs of second coordinates, and store, in the storage, the pair of first coordinates obtained by the procurement controller and the pair of second coordinates having a value of the pair of first coordinates;
a converter configured to, when the graphic pattern is present, convert the two or more pairs of first coordinates constituting the partial stroke into two or more pairs of converted coordinates constituting the graphic pattern;
a second updating controller configured to, when the graphic pattern is present, update values of the second pairs of second coordinates associated with the first pairs of first coordinates, from among the first number of pairs of first coordinates, constituting the partial stroke to values of third pairs of converted coordinates of the first pairs of first coordinates associated with the second pairs of second coordinates, and store, in the storage, the pair of first coordinates obtained by the procurement controller and the pair of second coordinates having a value of pair of converted coordinates; and
a display controller configured to display, on a display, the display stroke based on the second pairs of second coordinates stored in the storage.

2. The device according to claim 1, wherein
the storage is configured to store attribute information indicative of whether the pair of second coordinates has a first coordinates attribute or a converted coordinates attribute, in association with the pair of first coordinates,
the controller is configured to, when the attribute information indicates the first coordinates attribute, further obtain, from the storage, the attribute information associated with the pair of first coordinates that is newest in chronological order, and determine whether the graphic pattern similar to the partial stroke exists,
the first updating controller is configured to, when the graphic pattern is not present, further perform an update such that the attribute information associated with the first number of pairs of first coordinates indicates the first coordinates attribute, and store, in the storage, the attribute information indicative of the first coordinates attribute in association with the pair of first coordinates obtained by the procurement controller, and
the second updating controller is configured to, when the graphic pattern is present, further perform an update such that the attribute information associated with the first pairs of first coordinates, from among the first number of pairs of first coordinates, constituting the partial stroke indicates the converted coordinates attribute, and store, in the storage, the attribute information indicative of the converted coordinates attribute in association with the pair of first coordinates obtained by the procurement controller.

3. The device according to claim 1, wherein
the storage is configured to store attribute information indicative of whether the pair of second coordinates has a first coordinates attribute or a converted coordinates attribute, in association with the pair of first coordinates,
the controller is configured to, when the attribute information indicates the converted coordinates attribute, further obtain, from the storage, the attribute information associated with the pair of first coordinates that is newest in chronological order, and determine whether or not the partial stroke is similar to a previous graphic pattern which was determined to be similar in a previous determination,
the first updating controller is configured to, when the partial stroke is not similar to the previous graphic pattern, update values of the second pairs of second coordinates associated with the first number of pairs of first coordinates with values of the first pairs of first coordinates associated with the second pairs of second coordinates, perform an update such that the attribute information associated with the first number of pairs of first coordinates indicates the first coordinates attribute, and store, in the storage, the pair of first coordinates obtained by the procurement controller, the pair of second coordinates having the value of the pair of first coordinates, and the attribute information indicative of the first coordinates attribute,
the converter is configured to, when the partial stroke is similar to the previous graphic pattern, convert the two or more pairs of first coordinates constituting the partial stroke into two or more pairs of converted coordinates constituting the previous graphic pattern, and
the second updating controller is configured to, when the partial stroke is similar to the previous graphic pattern, update values of the second pairs of second coordinates associated with the first pairs of first coordinates, from among the first number of pairs of first coordinates, constituting the partial stroke to values of the third pairs of converted coordinates of the first pairs of first coordinates associated with the second pairs of second coordinates, perform an update such that the attribute information associated with the first pairs of first coordinates, from among the first number of pairs of first coordinates, constituting the partial stroke indicates the converted coordinates attribute, and store, in the storage, the pair of first coordinates obtained by the procurement controller, the pair of second coordinates having a value of pair of converted coordinates, and the attribute information indicative of the converted coordinates attribute.

4. The device according to claim 3, wherein
the controller is configured to, when the partial stroke is not similar to the previous graphic pattern, further determine whether the graphic pattern similar to the partial stroke exists,
the first updating controller is configured to, when the graphic pattern is not present, further perform an update such that the attribute information associated with the first number of pairs of first coordinates indicates the first coordinates attribute, and store, in the storage, the attribute information indicative of the first coordinates attribute in association with the pair of first coordinates obtained by the procurement controller, and
the second updating controller is configured to, when the graphic pattern is present, further perform an update such that the attribute information associated with the first pairs of first coordinates, from among the first number of pairs of first coordinates, constituting the partial stroke indicates the converted coordinates attribute, and store, in the storage, the attribute information indicative of the converted coordinates attribute in association with the pair of first coordinates obtained by the procurement controller.

5. The device according to claim 1, wherein the controller is configured to determine whether the graphic pattern for which an error with respect to the partial stroke is equal to or smaller than a threshold value exists.

6. The device according to claim 1, wherein the controller is configured to, when a plurality of partial strokes are similar to the graphic pattern, determine that a partial stroke having the largest number of constituent pairs of first coordinates is similar to the graphic pattern.

7. The device according to claim 1, wherein the graphic pattern is a straight line.

8. A stroke processing method implemented in a stroke processing device that includes storage configured to store a pair of first coordinates of an input stroke and a pair of second coordinates of a display stroke used for displaying in association with the pair of first coordinates every time the pair of first coordinated is obtained, the stroke processing method comprising:
obtaining the pair of first coordinates of the input stroke;
obtaining a first number of pairs of first coordinates previously stored in reverse chronological order from the storage every time the pair of first coordinates is obtained;
determining whether or not there exists a graphic pattern similar to a partial stroke made of two or more pairs of first coordinates comprising the pair of first coordinates obtained at the obtaining and at least one pair of first coordinates from among the first number of pairs of first coordinates;
when the graphic pattern is not present, updating values of second pairs of second coordinates associated with the first number of pairs of first coordinates with values of first pairs of first coordinates associated with the second pairs of second coordinates, and storing, in the storage, the pair of first coordinates obtained at the obtaining and the pair of second coordinates having a value of the pair of first coordinates;
converting, when the graphic pattern is present, the two or more pairs of first coordinates constituting the partial stroke into two or more pairs of converted coordinates constituting the graphic pattern;
when the graphic pattern is present, updating values of the second pairs of second coordinates associated with the first pairs of first coordinates, from among the first number of pairs of first coordinates, constituting the partial stroke to values of third pairs of converted coordinates of the first pairs of first coordinates associated with the second pairs of second coordinates, and storing, in the storage, the pair of first coordinates obtained at the obtaining and the pair of second coordinates having a value of pair of converted coordinates; and
displaying, on a display, the display stroke based on the second pairs of second coordinates stored in the storage.

9. A computer program product comprising a computer-readable medium containing a program executed by a computer that includes storage configured to store a pair of first coordinates of an input stroke and a pair of second coordinates of a display stroke used for displaying in association with the pair of first coordinates every time the pair of first coordinated is obtained, the program causing the computer to execute:
obtaining the pair of first coordinates of the input stroke;
obtaining a first number of pairs of first coordinates previously stored in reverse chronological order from the storage every time the pair of first coordinates is obtained;
determining whether or not there exists a graphic pattern similar to a partial stroke made of two or more pairs of first coordinates comprising the pair of first coordinates obtained at the obtaining and at least one pair of first coordinates from among the first number of pairs of first coordinates;
when the graphic pattern is not present, updating values of second pairs of second coordinates associated with the first number of pairs of first coordinates with values of the first pairs of first coordinates, and storing, in the storage, the pair of first coordinates obtained at the obtaining and the pair of second coordinates having a value of the pair of first coordinates;
converting, when the graphic pattern is present, the two or more pairs of first coordinates constituting the partial stroke into two or more pairs of converted coordinates constituting the graphic pattern;
when the graphic pattern is present, updating values of the second pairs of second coordinates associated with the first pairs of first coordinates, from among the first number of pairs of first coordinates, constituting the partial stroke to values of third pairs of converted coordinates of the first pairs of first coordinates associated with the second pairs of second coordinates, and storing, in the storage, the pair of first coordinates obtained at the obtaining and the pair of second coordinates having a value of pair of converted coordinates; and
displaying, on a display, the display stroke based on the second pairs of second coordinates stored in the storage.
